(19) United States
(12) Patent Application Publication
(10) Pub. No.: US 2021/0345703 A1
(43) Pub. Date: Nov. 11, 2021

(54) Mask or Visor Attachment for Eyewear, Eyewear with Integrated Mask or Visor, And Eyewear With Clip On Lenses

(71) Applicant: Brent SHELDON, Miami, FL (US)

(72) Inventors: Brent SHELDON, Miami, FL (US); Guy BROUSSEAU, Marieville (CA)

(73) Assignee: Brent SHELDON, Miami, FL (US)

(21) Appl. No.: 17/236,278

(22) Filed: Apr. 21, 2021

Related U.S. Application Data
(60) Provisional application No. 63/021,849, filed on May 8, 2020.
(60) Provisional application No. 63/024,838, filed on May 14, 2020.
(60) Provisional application No. 63/077,063, filed on Sep. 11, 2020.

(51) Int. Cl. A41D 13/11; A62B 7/10; A62B 23/02; A62B 18/08; G02C 11/08; G02C 11/00

(52) U.S. Cl. CPC A41D 13/1161; A62B 7/10; A62B 23/025; G02C 2200/02; G02C 11/08; G02C 11/12; A62B 18/084

(57) ABSTRACT

A mask to be attached to eyewear is provided. The mask includes a shroud, the shroud including one or more attachment points to couple to corresponding attachment points on the eyewear. The mask also includes a filter assembly, the filter assembly including one or more openings and a filter layer covering the one or more openings to permit air flow through the mask while filtering for contaminants. Also provided are a filter assembly for a mask, an assembly including the mask and eyewear, integrated masks/visors/eyewear, and an assembly including the mask, eyewear, and a clip on lens attachment.

### CROSS-REFERENCE TO RELATED APPLICATIONS

This application claims priority to U.S. Provisional Patent Application Nos. 63/021,849 filed on May 8, 2020; 63/024,838 filed on May 14, 2020; and 63/077,063 filed on Sep. 11, 2020; the contents of these applications being incorporated by reference in their entirety.

### TECHNICAL FIELD

The following relates generally to eyewear and more specifically to mask or visor attachments for eyewear, eyewear configured to be coupled with detachable masks or visors and/or clip on lenses, eyewear with integrated masks or visors, and eyewear with masks or visors and clip on lens assemblies.

### BACKGROUND

Of the protective personal equipment (PPE) that is becoming increasingly required or recommended to limit the spread of pathogens such as viruses and bacteria, facial masks that are designed to cover a person's mouth, nose and other parts of the face are especially common. For this purpose, masks have traditionally been used by healthcare professionals but are now increasingly being used by the general public.

Masks are also widely used in construction and other industrial settings to limit exposure to contaminants like dust, debris, gases, fumes, liquids, etc. Many of these masks are disposable since the filtration feature, often a layer of material, can wear out and lose its effectiveness, as well as can lose its ability to form-fit to the user's face. Reusable masks do exist but are often difficult to clean or to have the filters changed.

Moreover, many masks are designed to use a pair of loops, often from an elastic material, that fit around the user's ears. Not only does this tend to pull the mask fabric towards and against the user's face, the elastic loops tend to pull down on the user's ears making the use of a mask often uncomfortable for the wearer. For health and construction workers and, more recently the general public, that may need to wear the masks for long periods of time, this discomfort is exacerbated.

Wearing a mask at the same time as eyewear, be it prescription glasses, sunglasses or protective eyewear; can create additional issues to those discussed above. For instance, masks are typically designed to be used for a wide population and thus sizing and fitment is typically generic or “one size fits all/many”. This leads to difficulties fitting a mask around and under eyewear, can lead to improper fitment around the user's nose and mouth, or can dislodge the eyewear or otherwise make it uncomfortable to wear both at the same time. Additionally, even more so than sizing and fitment, fogging can become a major problem. Wearing a mask naturally redirects a user's exhalations such that additional air moves towards and under the eyewear causing lenses to become foggy. This can be both bothersome and even dangerous to the user since it can impede the user's vision and field of view.

It is an object of the following to address at least one of the above-noted disadvantages.

### SUMMARY

Provided herein is a detachable mask or visor that can be coupled to eyewear such as eyeglasses or safety glasses. The mask or visor and eyewear suited to be coupled to the mask can form a mask or visor and eyewear “assembly” with detachable components to permit the mask or visor to be detached and reattached to the eyewear using a suitable coupling mechanism such as one or more magnets. By coupling the mask or visor directly to the eyewear rather than the wearer's face (e.g., via ear loops) the permeable portion of the mask (or barrier of the visor) can be separated from the wearer's face. A rim portion can also be provided on the mask to provide a comfortable interface with the wearer's face above and/or around the mouth to inhibit air flow from the wearer's exhalations from reaching the eyewear lenses. The mask can also include a detachable filter cover to enable a filter layer in the mask to be conveniently replaced even without removing the mask from the eyewear. This filter cover can also be coupled to a shroud of the mask using a suitable coupling mechanism such as one or more magnets. The masks and visors described herein can also be integrated with or fixedly coupled to eyewear. Moreover, clip-on or other detachable eyewear accessories such as sunglass lenses can be accommodated with the masks and visors, in both detachable and fixed configurations wherein the mask/visor and eyewear are unitary.

In one aspect, there is provided a mask to be attached to eyewear, comprising: a shroud, the shroud comprising one or more attachment points to couple to corresponding attachment points on the eyewear; and a filter assembly, the filter assembly comprising one or more openings and a filter layer covering the one or more openings to permit air flow through the mask while filtering for contaminants.

In another aspect, there is provided a filter assembly for a mask, the filter assembly comprising: one or more openings in the mask; a filter layer covering the one or more openings to permit air flow through the mask while filtering for contaminants; and an outer grid to be coupled to the mask over the filter layer and aligned with the one or more openings.

In yet another aspect, there is provided an assembly comprising: a mask as defined above and the eyewear.

In yet another aspect, there is provided an assembly comprising a mask as defined above, eyewear, and a clip on lens attachment. That is, the clip on lens attachment can be used with the same eyewear configured to be coupled to a mask.

In yet another aspect, there is provided a mask to be attached to eyewear, comprising: a shroud, the shroud comprising one or more attachment points to couple to corresponding attachment points on the eyewear; wherein the shroud is at least partially transparent or translucent to permit visibility through the mask.

In yet another aspect, there is provided eyewear comprising: a frame configured to retain one or more lenses; a pair of arms; and a mask coupled to the frame, the mask comprising a shroud sized and positioned to cover a nose and mouth of the wearer; wherein the shroud is at least partially transparent or translucent to permit visibility through the mask.

### BRIEF DESCRIPTION OF THE DRAWINGS

Embodiments will now be described with reference to the appended drawings wherein:

FIG. 1 is a perspective view of a mask and eyewear assembly showing the mask in a detached position.

FIG. 2 is a perspective view of the assembly shown in FIG. 1 with the mask in an attached position.

FIG. 3 is a perspective view of another example of a mask and eyewear assembly showing the mask in a detached position.

FIG. 4 is a perspective view of the assembly shown in FIG. 3 with the mask in an attached position.

FIG. 5a is a perspective view of yet another example of a mask and eyewear assembly showing the mask in a detached position.

FIG. 5b is a perspective view of the assembly shown in FIG. 5a with the mask in an attached position.

FIGS. 5c, 5d, and 5e are perspective views of yet another example of a mask and eyewear assembly configured to be used with clip on lens attachments with or without the mask.

FIG. 6a is a perspective view of yet another example of a mask and eyewear assembly showing the mask in a detached position.

FIG. 6b is a perspective view of the assembly shown in FIG. 6a with the mask in an attached position.

FIGS. 6c, 6d, and 6e are perspective views of alternative mounting arrangements for the example of FIGS. 6a-6b.

FIG. 7 is an exploded perspective view of a detachable mask that can be coupled to eyewear to form a mask and eyewear assembly.

FIG. 8 is a partially assembled view of the detachable mask shown in FIG. 7.

FIG. 9 is an assembled view of the detachable mask shown in FIG. 7.

FIG. 10 is front perspective view of a detachable mask with a soft inner rim darkened for illustrative purposes.

FIG. 11 is a rear perspective view of the mask as shown in FIG. 10.

FIG. 12 is a cross-sectional perspective view of the assembly shown in FIG. 1 illustrating a separation gap between the mask shroud and the user's face.

FIG. 13 is a cross-sectional side view of the assembly shown in FIGS. 1 and 12.

FIG. 14 is an enlarged partial cross-sectional view showing an interface between the mask and the user's face to inhibit fogging.

FIG. 15a is a simulation image of a human coughing into a traditional style of mask.

FIG. 15b is a simulation image of a human coughing into a mask such as that shown and described herein.

FIG. 16 is an exploded perspective view of a detachable visor-style mask that can be coupled to eyewear to form a mask and eyewear assembly.

FIG. 17 is an assembled view of the visor-style mask and eyewear illustrated in FIG. 16.

### DETAILED DESCRIPTION

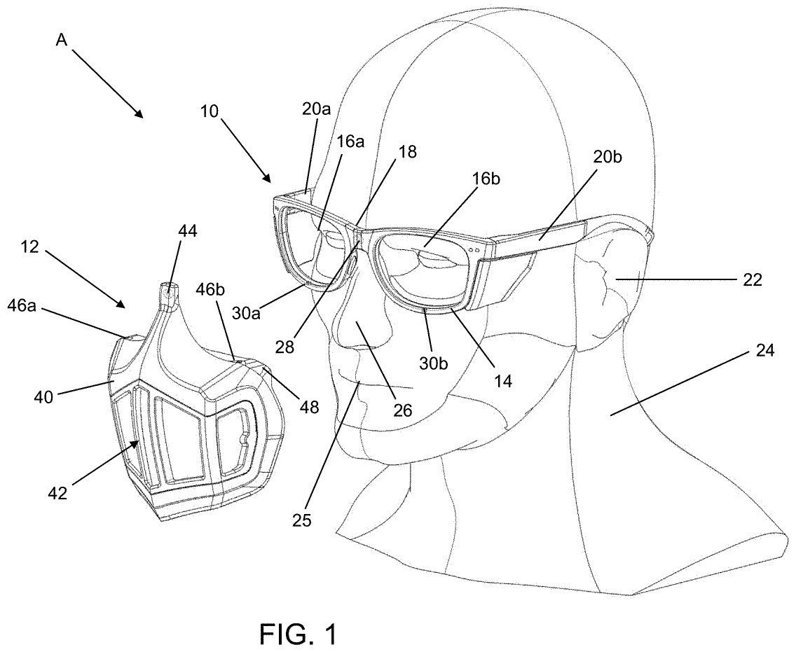

Turning now to the figures, FIG. 1 an assembly A is shown in a decoupled state. The assembly A includes eyewear 10 and a mask 12. The eyewear 10 can include prescription eyeglasses, sunglasses, protective or safety glasses or any other type of eyewear 10. The eyewear 10 shown in FIG. 1 includes a frame 14 that contains one or more lenses 16 and a bridge 18, in this example a pair of lenses 16a, 16b separated by the bridge 18. The bridge 18 rests on the nose 26 of a wearer 24. It can be appreciated that in other types of eyewear 10 nose pieces (not shown) may extend from the bridge 18 rather than resting directly on the wearer 24. The frame 14 also has extending therefrom a pair of arms 20 (also sometimes referred to as temples or temple portions), in this example a first arm 20a and a second arm 20b. The arms 20a, 20b rest on the wearer's ears 22 as is known in the art.

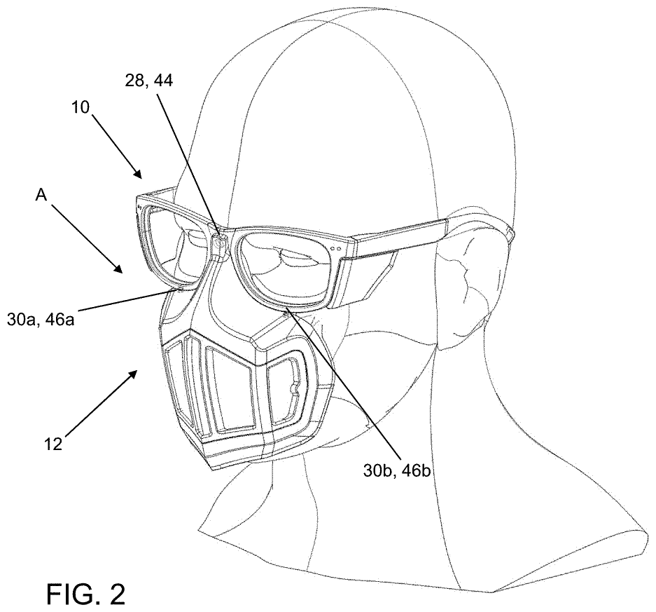

In the examples described herein, the eyewear 10 includes a set of one or more magnets to provide a coupling mechanism between it and the mask 12. In the example shown in FIG. 1, the eyewear 10 includes a three-point magnetic coupling mechanism with a central magnet 28 on or embedded in the bridge 18 and a pair of frame magnets 30a, 30b positioned in or along the frame 14 below the respective lenses 16a, 16b. While the use of magnets for the coupling mechanism is particularly advantageous for quick coupling and release functionality, it can be appreciated that the mask 12 can also be coupled to the eyewear 10 either in a detachable or permanent fashion (fixed or integral) in other embodiments. For example, hooks, frictional engagement, or other coupling mechanisms can be used. Moreover, it can be appreciated that the ability to attach the mask 12 to the eyewear 10 can be achieved by using an additional attachment piece (not shown) that effectively retrofits the eyewear 10 (or mask 12) to include magnetic attachment or other attachment mechanisms. For example, existing eyewear 10 could be provided with a clip on or adhesive attachment component that is/are attached to the eyewear 10 in suitable locations to mate with magnets on the mask 12. That is, the introduction of an additional attachment to achieve the same connection capabilities would not depart from the principles discussed herein. In this way, any eyewear 10 could be adapted to be used with the mask system described herein. Also, versions of the assembly A can be provided with a permanently attached mask 12 or unitary mask and eyewear assembly (e.g., to resemble the assembled configuration shown in FIG. 2) that takes advantage of the filter assembly and airflow control mechanisms described below.

The mask 12 shown in FIG. 1 is releasably coupled to the eyewear 10 to cover the nose 26, mouth 25 and more generally the wearer's face below the eyewear 10. The mask 12 includes a body or shroud 40 that is sized and contoured to fit up against the bottom of the frame 14 of the eyewear 10 and to place a filter assembly 42 away from direct contact with the wearer's mouth 25 and nose 26. The shroud 40 includes a central upper peaked portion containing or supporting a central mask magnet 44 that is positioned to magnetically couple with the bridge magnet 28 when the mask 12 engages the eyewear 10. The mask 12 in this example also includes a pair of outer mask magnets 46a, 46b that are positioned to couple with the frame magnets 30a, 30b respectively. Also shown in FIG. 1 is a seal 48 placed along the inner rim of the shroud 40 to provide both sealing properties and protective properties, e.g., to provide a relatively softer surface against the wearer's face during an impact against the assembly A. Further detail concerning these properties are discussed later. It can be appreciated that as noted above, the features and configuration of assembly A can also be provided in a fixed or otherwise non-detachable embodiment. For example, the mask 12 can be fixedly coupled to or integrated with the eyewear 10 providing a unitary assembly (e.g., in one piece) that is similar to if not nearly identical to the combined assembly (see FIG. 2, for example).

FIG. 2 illustrates the assembly A from FIG. 1 in a coupled state wherein the central mask magnet is coupled with the bridge magnet 18 via magnetic attraction. Similarly, the outer mask magnets 46a, 46b are coupled with the frame magnets 30a, 30b via magnetic attraction. In this way, the mask 12 can be “clipped” or “snapped” onto the eyewear 10 in a quick release coupling fashion to permit convenient attachment and detachment of the mask 12 when in use. This is particularly advantageous when the wearer 24 uses the mask 12 sporadically. For example, the wearer 24 may not use the mask 12 while driving or inside their home but need to snap it in place to enter a store or workplace or other public area.

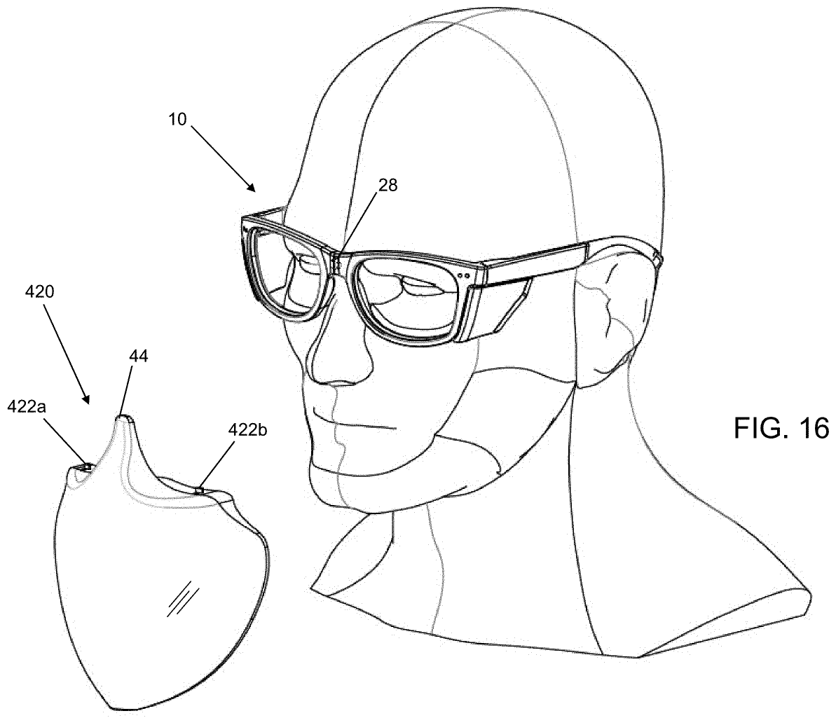

The use of a three point coupling mechanism using the magnets 28, 30a, 30b, 44, 46a, 46b, provides additional stability when coupled together, and assists in aligning the mask 12 with the eyewear 10, since the mask 12 will be urged into place by the magnetic attraction. The multiple magnetic pairings also increase the strength of attachment making the mask 12 less susceptible to becoming dislodged. As illustrated in FIG. 16 and discussed below, the mask 12 or eyewear 10 can also include posts, ridges or other structures that serve to position the mask 12 relative to the eyewear 10, e.g., to resist dislodgement of the mask 12 relative to the eyewear 10.

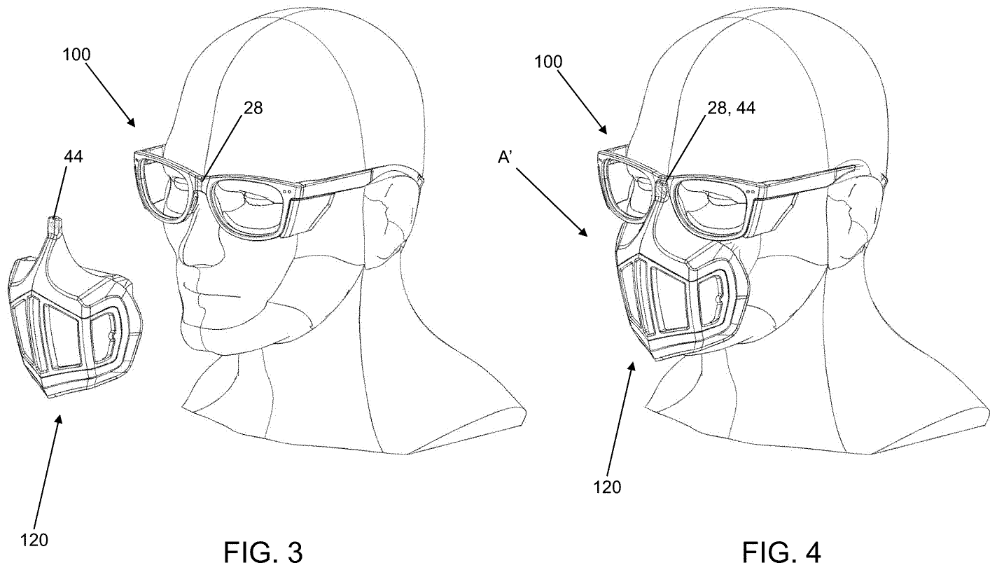

FIGS. 3 and 4 provide an alternative assembly A′ in which eyewear 100 is coupled to a mask 120 using a single magnetic attachment point. In this example, the eyewear 100 includes only the bridge magnet 28 and the mask 120 includes only the central mask magnet 44 with the fitment relative to each other as shown in FIG. 4 being similar to that shown in FIG. 2. In this example, the assembly A′ relies on the central magnetic attachment point to couple the mask 120 to the eyewear 100. It can be appreciated that in this configuration a relatively stronger or larger magnetic member can be used to compensate for having fewer attachment points. It can be appreciated that the embodiment shown in FIGS. 3 and 4 illustrates that various attachment/coupling arrangements are possible without departing from the principles discussed herein. For example, the assembly A′ could instead use a clip or alignment ridge (not shown) in the central portion and use the frame magnets 30a, 30b and outer mask magnets 46a, 46b to provide the coupling mechanism through magnetic attraction. Similarly, as discussed above, the central magnetic member 28 can also be used with posts, ridges or other structures to help position the mask 12 relative to the eyewear 10 and resist dislodgement of the mask 12.

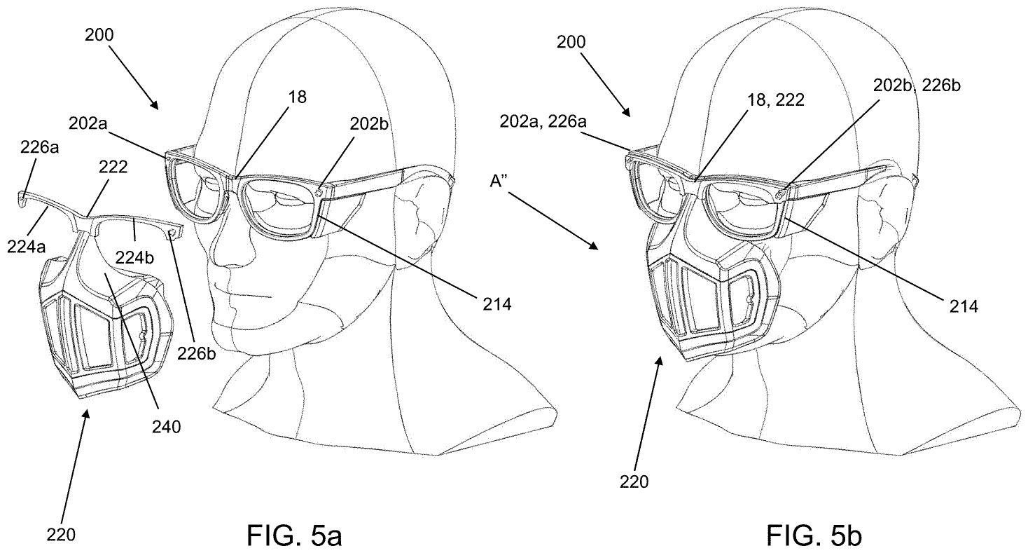

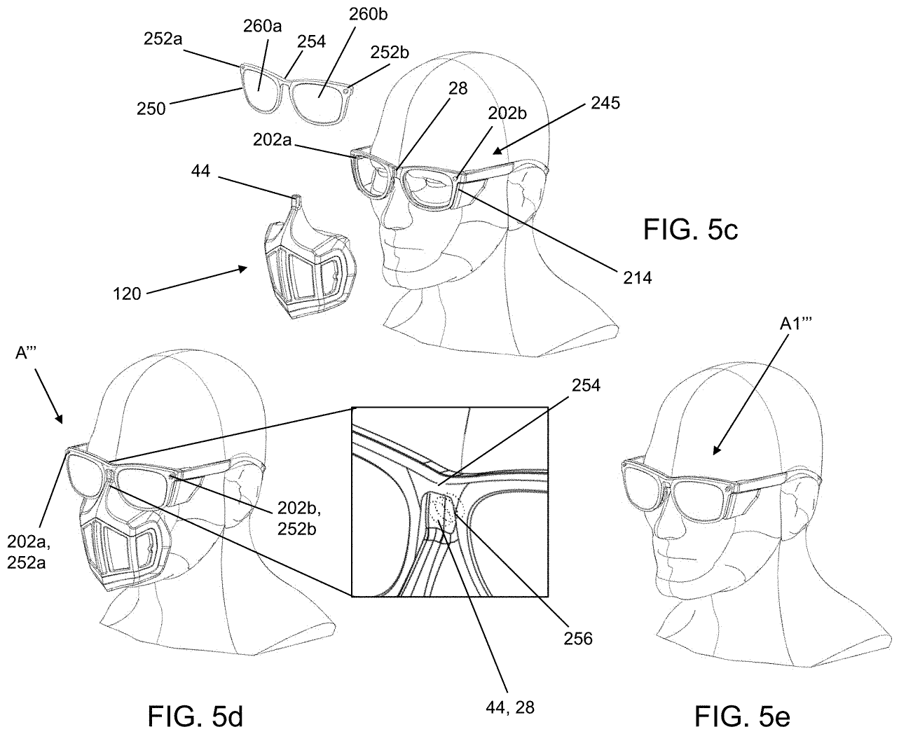

FIGS. 5a and 5b provide yet another alternative assembly A″ in which eyewear 200 is coupled to a mask 220 using a pair of magnetic attachment points at either end of a brow portion of the frame 214. As seen in FIG. 5a, the eyewear 200 includes outer magnets 202a, 202b that are positioned on the front face of the frame 214 near where the frame 214 is attached to the arms. On the mask 220 the shroud 240 includes a central brow bar 222 with extensions that follow the contouring of the brow portion of the frame 214 and that position a pair of outer mask magnets 226a, 226b to align with the outer magnets 202a, 202b of the eyewear 200. In this way, the central portion of the brow bar 222 aligns with the bridge 18 of the eyewear 200 when the magnets 202a, 226a and 202b, 226b are coupled as shown in FIG. 5b. Similar to what is shown in FIGS. 3 and 4, it can be appreciated that various coupling mechanisms and arrangements of the magnets are possible without departing from the principles discussed herein.

FIGS. 5c, 5d, and 5e provide yet another alternative assembly A′″ in which eyewear 245 is configured to include a set of magnetic attachment points that allow for both a mask 120 and a clip on attachment 250 to be coupled thereto. That is, the eyewear 245 is adapted to allow for either or both a mask 120 and clip on attachment 250 to be attached thereto interchangeably. It will be appreciated that this configuration can also be adapted to include a permanent or fixed mask 120 and clip on attachment 250. The clip on attachment 250 includes a pair of clip on lenses 260a, 260b that are separated by a bridge portion 254. The bridge portion 254 of the clip on attachment 250 is sized and contoured to accommodate the presence of the central magnet 44 of the mask 120. The clip on attachment 250 also includes outer magnets 252a, 252b that are positioned at the outer corners of the clip on attachment 250 to be aligned with the outer magnets 202a, 202b of the eyewear 245. The eyewear 245 also includes a bridge magnet 28, e.g., as shown in FIG. 1, to permit the central magnet 44 of the mask 120 to be attached thereto. Although not shown in FIGS. 5c-5e, the eyewear 245 may also be configured to include additional magnets, e.g., as shown in FIG. 1, along the underside of the rim. As shown in the inset for FIG. 5d, the clip on attachment's bridge portion 254 sits flush with the brow portion of the eyewear 245 while providing a sufficient gap 256 to accommodate the central magnet 44 of the mask 120 to allow it to be aligned with the bridge magnet 28 of the eyewear 245. FIG. 5e illustrates that the clip on attachment 250 can be readily used with the eyewear 245 without the mask 120 without any compromise to the aesthetics of the overall alternative assembly A1′″. It can be appreciated that the mask 220 shown in FIGS. 5a, 5b can also be used with the clip on attachment 250 shown in FIGS. 5c-5e interchangeably. Moreover, the attachment 250 could also be configured to attach on top of the brow bar 222. Thus, many configurations are possible to have an assembly with a mask, eyewear, or integrated mask/eyewear, and clip on attachment.

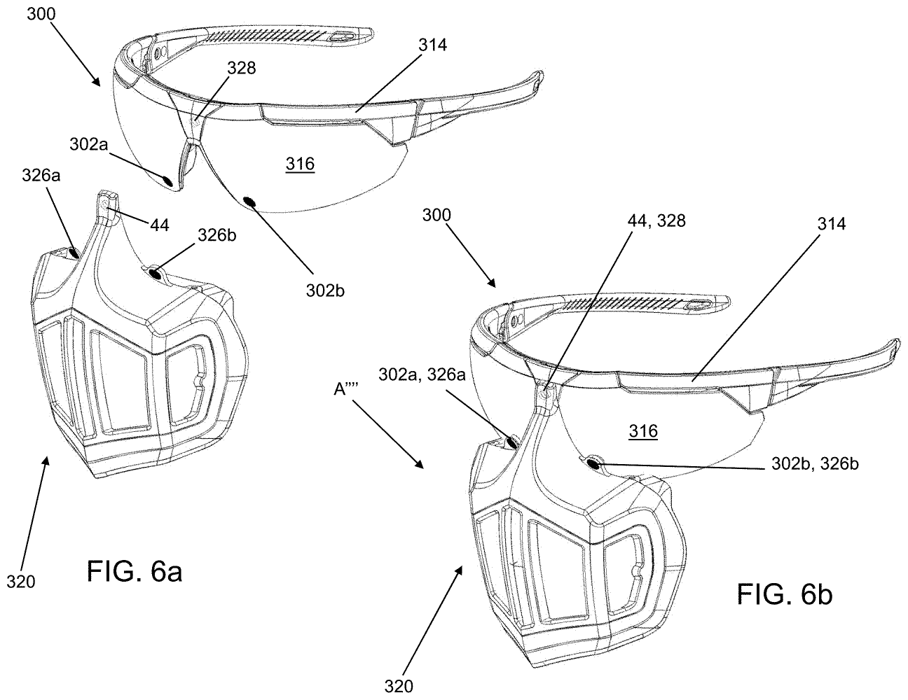

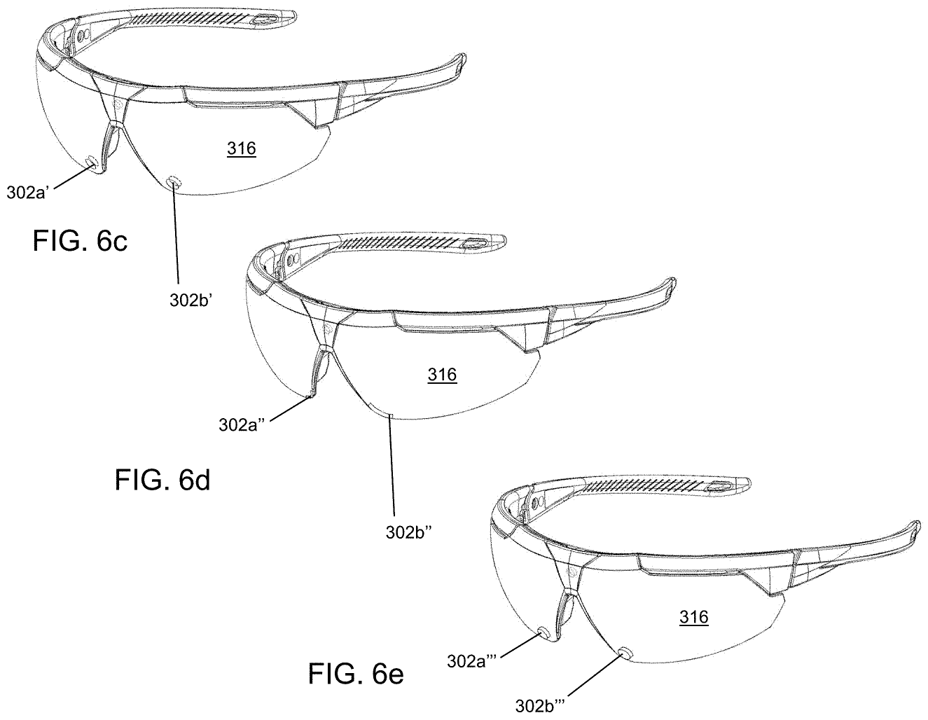

FIGS. 6a and 6b provide yet another alternative assembly A“ ” applied to eyewear 300 having a plano-type lens 316 with a brow bar frame 314. The eyewear 300 is coupled to a mask 320 using a set of three magnets, similar to the implementation shown in FIGS. 1-2. In this example, the mask 320 includes the central magnet 44 that interfaces with a bridge magnet 328, and a pair of fore/aft facing outer magnets 326a, 326b positioned to interface with lens magnets 302a, 302b embedded in the plano lens 316 as seen in FIG. 6b. While the lens magnets 302a, 302b are shown as being inserted or embedded in the plano lens 316 it can be appreciated that such magnets could instead be affixed to the lens 316 or provided by way of a separate attachment piece (not shown) as discussed above. As with the other example implementations discussed above, while a set of three magnetic attachment points is shown in FIGS. 6a, 6b, it can be appreciated that a single bridge connection or only lens connections could be implemented. Moreover, as shown in FIGS. 6c, 6d, and 6e, the magnets 302a, 302b can be mounted or otherwise incorporated into the plano lens 316 in various ways. In FIG. 6c, the lens 316 is adapted to include holes or openings 302a′, 302b′ for magnets 302a, 302b to be embedded. In FIG. 6d, the magnets 302a″, 302b″ are shaped to follow the contour of the plan lenses 316 and can be embedded along the edge as shown to provide a flush surface. In FIG. 6e the magnets 302a′″, 302b′″ are attached on top of the lenses 316.

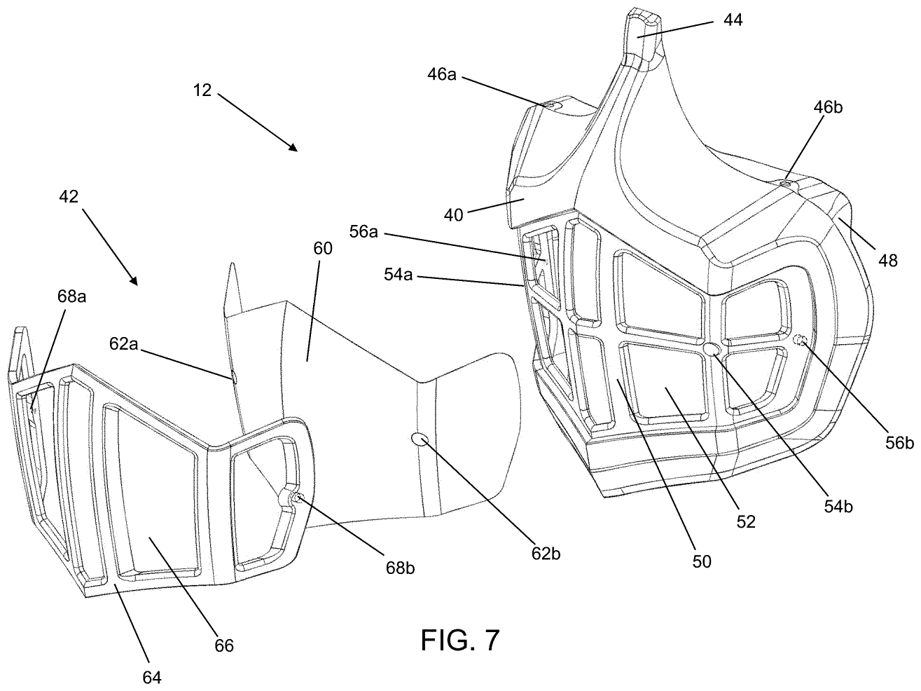

Turning now to FIGS. 7 to 9, further details concerning an embodiment of the mask 12 are shown. In the exploded view of FIG. 7, it can be seen that the shroud 40 includes a recessed inner grid 50 that is structured to provide a “grid” of openings 52 to permit airflow through the mask 12. The inner grid 50 includes a pair of alignment posts 54a, 54b to assist in positioning a filter layer 60 within the recess of the shroud 40 and against the inner grid 50. The inner grid 50 also includes a pair of attachment magnets 56a, 56b to permit an outer grid 64 to be coupled to shroud 50 in alignment with the inner grid 50 and to cover and contain the filter layer 60.

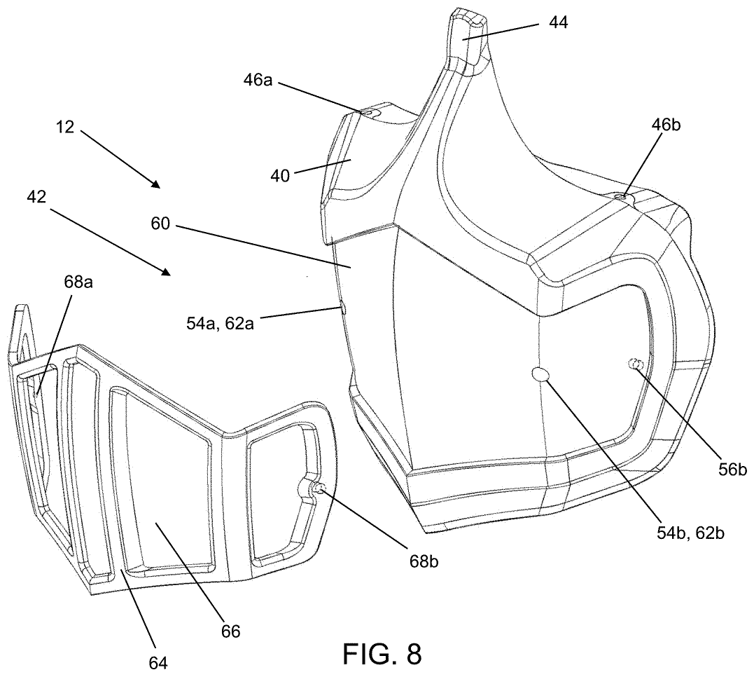

The filter layer 60 is shaped to be seated within the recess of the shroud 40 against the inner grid 50. The filter layer 60 includes a pair of alignment holes 62a, 62b that are sized and positioned to allow the posts 54a, 54b to extend therethrough. In this way, the filter layer 60 completely covers the openings 52 to provide a permeable layer of protection while permitting breathing as shown in FIG. 8. The filter layer 60 can be composed of various materials from non-medical or dust filtering to surgical or medical grade like N95.

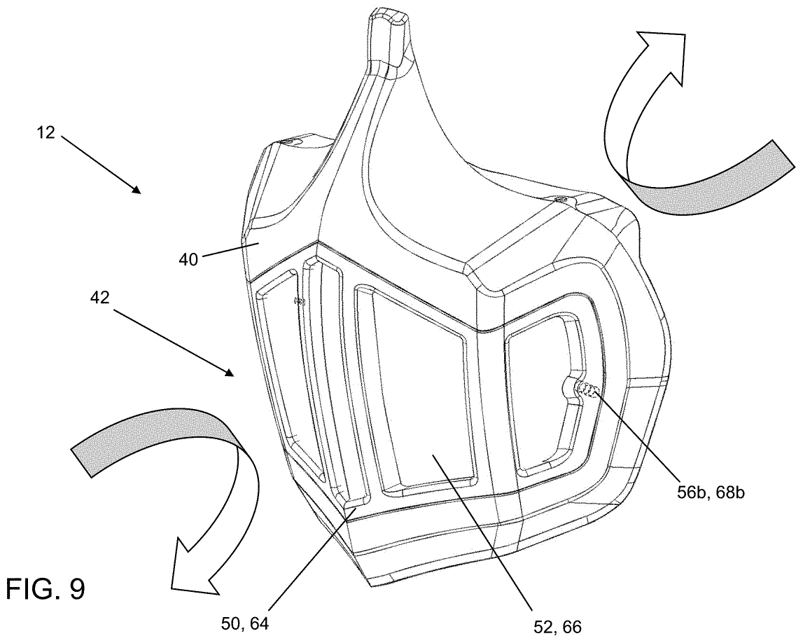

To hold the filter layer 60 in place, the outer grid 64 is attached to the inner grid 50 as shown in FIG. 9. The outer grid 64 includes a series of openings 66 that are sized to provide an optimal air flow through the outer grid 64 while permitting attachment to the inner grid 50 and containment of the filter layer 60 therebetween. The outer grid 64 includes a pair of attachment magnets 68a, 68b that are positioned to be in alignment with the magnets 56a, 56b of the inner grid 50. By having the recessed portion of the shroud 40 both the filter layer 60 and the outer grid 64 can be accommodated to provide a substantially flush outer surface as shown in FIG. 9. At the same time, the magnetic attachment of the outer grid 64 allows the filter layer 60 to be accessed with ease for removal and replacement. This can even be performed while the mask 12 is coupled to the eyewear 10 providing a convenient quick change mechanism for the filter layer 60. It can be appreciated that other attachment mechanisms can be used, including tabs, snaps, etc.

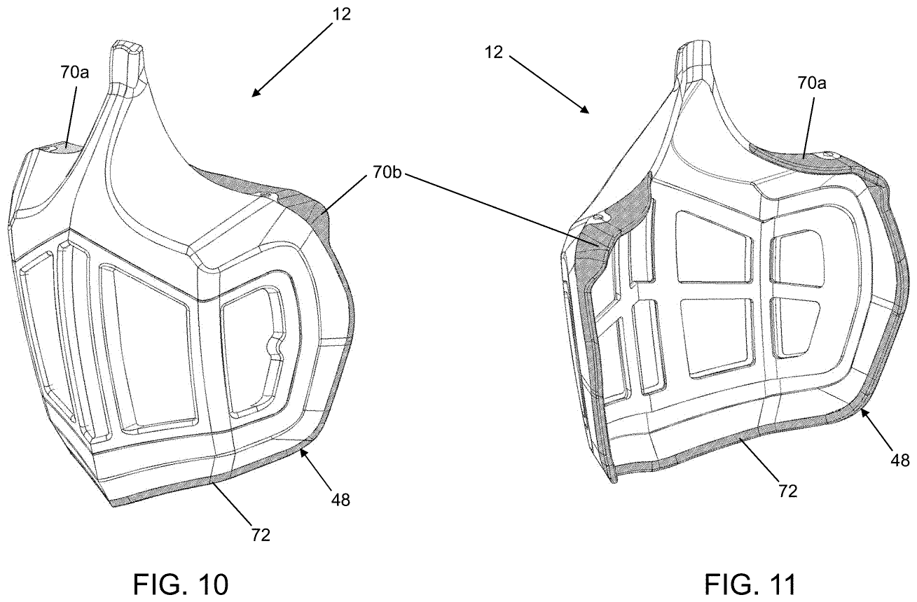

Turning now to FIGS. 10 and 11, further detail concerning the seal 48 that is placed along the inner rim of the shroud 40 is shown. In these views the seal 48 is darkened for illustrative purposes. As can be seen in these figures, the seal 48 provides a protective layer between the material of the shroud 40 and the wearer's face. This includes a lower rim portion 72 and upper antifog barriers 70a, 70b. The seal 48 can therefore be considered a partial seal against the wearer 24 while also providing a protective layer by using a relatively softer material. The softer material for the seal 48 can be attached to or overmolded with the rim of the shroud 40.

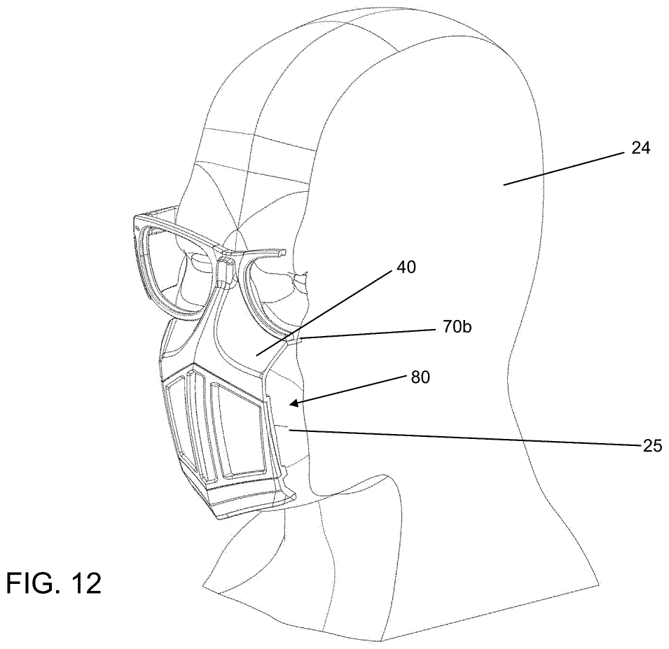

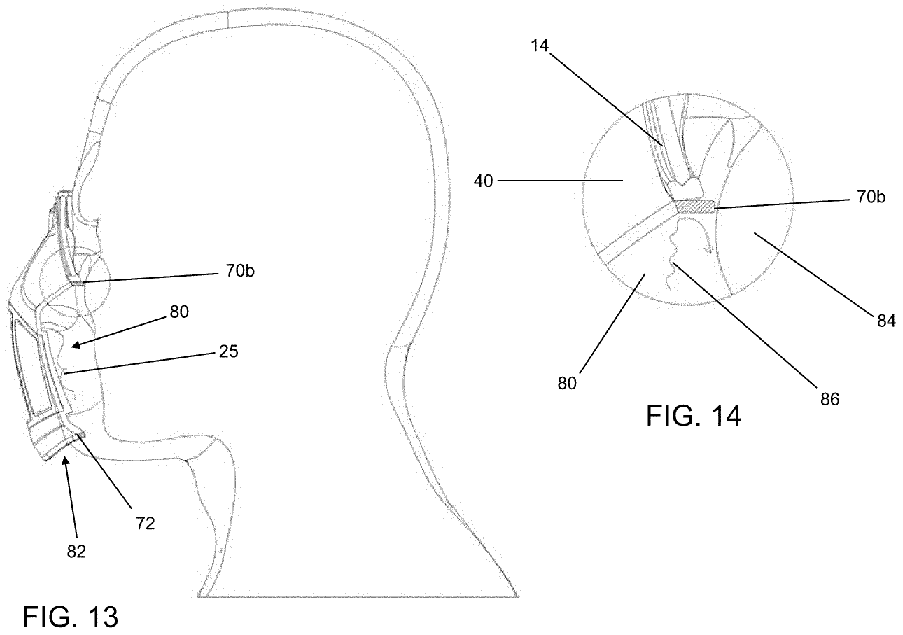

The functionality of the antifog barriers 70a, 70b can be observed in FIGS. 12 to 14. Referring first to FIG. 12 the cross-sectional view illustrates how the shroud 40 can extend away from the wearer's face to provide a gap 80. This gap 80 not only prevents the mask 12 from coming into contact with the wearer's mouth 25 but also provides room for air being exhaled by the wearer 24 to flow and be guided downwardly an out from behind the mask 12 as best seen in FIGS. 13 and 14. Referring now to FIGS. 13 and 14, the cross-sectional view of the antifog barriers 70a, 70b can be seen providing a partial seal above the wearer's mouth 25 and below the eyewear 10 while providing a softer engagement against the skin. As seen in FIG. 14, air flow 86 can be redirected by the barrier 70b away from the eyewear 10 and toward the bottom area of the gap 80 where it can flow through a lower escape gap 82 seen in FIG. 13.

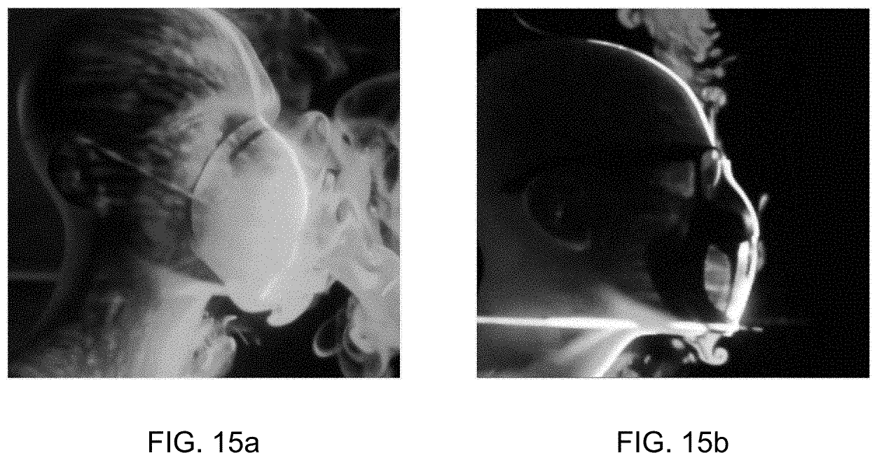

To further illustrate the practical effectiveness of the mask 12 described herein, FIGS. 15a and 15b illustrate a simulated human cough profile. In FIG. 15a it can be observed that a typical mask, such as a medical mask or shop mask may allow significant flow around and away from the user. In contrast, the simulation shown in FIG. 15b illustrates how the assembly described herein can limit such flow, particularly due to the blockages provided by the anti-fog barriers 70a, 70b.

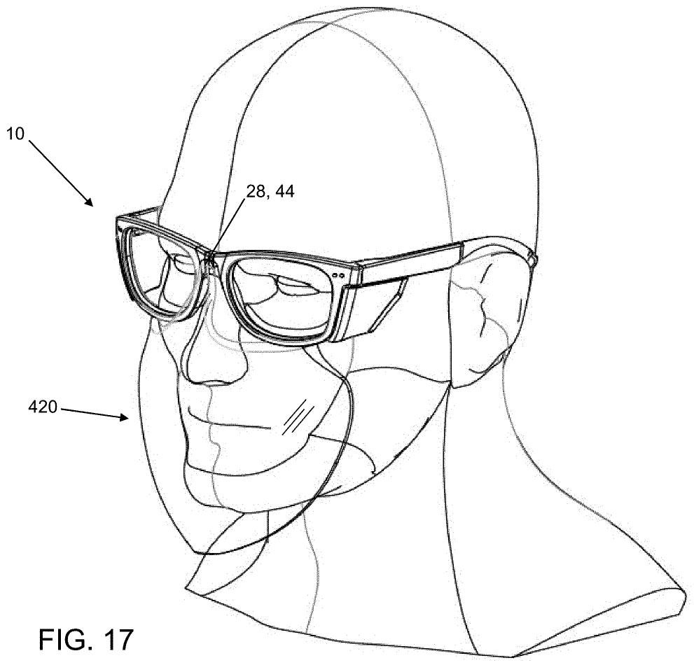

Turning now to FIGS. 16 and 17, a clear mask or shield can also be used in the configurations shown herein, also referred to herein as a “visor” 420. It is found that in some applications, the ability to see a user's facial expressions, including lip movements and emotions is important. In such cases, a mask 12 can be detrimental or at least less than ideal. The assembly A can thus be configured to accommodate a transparent or at least partially clear or translucent material in at least a portion but ideally a substantial portion of the visor 420. It can be appreciated that the visor 420 can be made detachable using the same or similar magnetic attachment configurations described above or be fixed to the eyewear 10. In the example shown in FIG. 16, the visor 420 includes a central magnet 44 that magnetically couples to the bridge magnet 28.

FIG. 16 also illustrates an additional feature that can be incorporated into the visor 420, or any of the mask embodiments described above. Along the upper surface of the visor 420 are posts 422a, 422b. The posts 422a, 422b can be positioned to fit up and under the eyewear 10 behind the lower portions of the frame that contain the lenses. In this way, the posts 422a, 422b can server to position the visor 420 relative to the eyewear 10, e.g., to resist dislodgement of the visor 420 relative to the eyewear 10.

As shown in FIG. 17, when attached to the eyewear 10, the visor 420 permits the user's nose and mouth to be visible. This allows the user's facial expressions, e.g., smile or frown, as well as movement of their lips, to be observed by others. The transparent visor 420 can be particularly suitable for service industries, school environments or other applications where visual communication is important.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A mask to be attached to eyewear, comprising:
a shroud, the shroud comprising one or more attachment points to couple to corresponding attachment points on the eyewear; and
a filter assembly, the filter assembly comprising one or more openings and a filter layer covering the one or more openings to permit air flow through the mask while filtering for contaminants.

2. The mask of claim 1, wherein the one or more attachment points comprise magnets for magnetic attraction to corresponding magnets on the eyewear.

3. The mask of claim 2, comprising a central magnet to be attached to a bridge portion of the eyewear.

4. The mask of claim 3, further comprising a pair of outer magnets to be attached to a frame of the eyewear.

5. The mask of claim 4, wherein the outer magnets are attached to the underside of the frame.

6. The mask of claim 2, comprising a pair of outer magnets on extensions from a central portion of the shroud, to be attached to a frame of the eyewear.

7. The mask of claim 6, wherein the outer magnets are attached to a front face of the frame.

8. The mask of claim 1, further comprising a layer of material along an inner rim of the shroud.

9. The mask of claim 8, wherein the layer of material comprising a pair of antifog barriers along an upper portion of the rim to bear against a wearer's face below the eyewear.

10. The mask of claim 8, wherein the layer of material extends along the entirety of the rim to provide a comfort layer.

11. The mask of claim 1, wherein the shroud comprises a recessed portion to receive the filter layer and the filter assembly comprises an outer grid that attaches to the shroud over the filter layer.

12. The mask of claim 11, wherein the recessed portion comprises an inner grid, the inner grid comprising one or more magnets to couple with one or more magnets on the outer grid to permit access to the filter layer.

13. The mask of claim 11, wherein the filter layer is positioned in the recess using a pair of posts aligned with alignment holes in the filter layer.

14. The mask of claim 12, wherein the inner and outer grids each define a plurality of openings to permit the air flow.

15. A filter assembly for a mask, the filter assembly comprising:
one or more openings in the mask;
a filter layer covering the one or more openings to permit air flow through the mask while filtering for contaminants; and
an outer grid to be coupled to the mask over the filter layer and aligned with the one or more openings.

16. The filter assembly of claim 15, wherein the plurality of openings are provided in a recessed portion in the mask.

17. The filter assembly of claim 16 wherein the recessed portion comprises an inner grid, the inner grid comprising one or more magnets to couple with one or more magnets on the outer grid to permit access to the filter layer.

18. The filter assembly of claim 16, wherein the filter layer is positioned in the recessed portion using a pair of posts aligned with alignment holes in the filter layer.

19. The filter assembly of claim 17, wherein the inner and outer grids each define a plurality of openings to permit the air flow.

20. An eyewear assembly comprising:
a mask, the mask comprising:
a shroud, the shroud comprising one or more attachment points to couple to corresponding attachment points on eyewear; and
a filter assembly, the filter assembly comprising one or more openings and a filter layer covering the one or more openings to permit air flow through the mask while filtering for contaminants; and
the eyewear.

21. The assembly of claim 20, further comprising:
a lens attachment to be coupled to the eyewear.

22. A mask to be attached to eyewear, comprising:
a shroud, the shroud comprising one or more attachment points to couple to corresponding attachment points on the eyewear;
wherein the shroud is at least partially transparent or translucent to permit visibility through the mask.

23. Eyewear comprising:
a frame configured to retain one or more lenses;
a pair of arms; and
a mask coupled to the frame, the mask comprising a shroud sized and positioned to cover a nose and mouth of the wearer.

24. The eyewear of claim 23, wherein the mask is integral with, or fixedly coupled to, the eyewear.

25. The eyewear of claim 23, wherein the mask is attachable and detachable from the frame.
